(19) United States
(12) Patent Application Publication
(10) Pub. No.: US 2022/0076291 A1
(43) Pub. Date: Mar. 10, 2022

(54) METHOD AND SYSTEM FOR ALLOCATING A COMMERCIAL BUDGET ACROSS BRANDS AND COMMERCIAL CHANNELS

(71) Applicant: Cozmix, Inc., Lake Mary, FL (US)

(72) Inventor: Stephen Maughan, Longwood, FL (US)

(21) Appl. No.: 17/467,558

(22) Filed: Sep. 7, 2021

Related U.S. Application Data
(60) Provisional application No. 63/075,282, filed on Sep. 7, 2020.

(51) Int. Cl. G06Q 30/02

(52) U.S. Cl. CPC G06Q 30/0249; G06Q 30/0244; G06Q 30/0246

(57) ABSTRACT

A process and a system are provided to determine how to allocate the available commercial resources for a plurality of brands in a plurality of commercial channels. The use of brand response curves, in addition to commercial response curves, accounts for overlap and redundancy that are present with just the use of commercial response curves. The process uses the brand response curves and optimization technology to determine the allocation of the total commercial budget for each of the brands. The process then uses the commercial response curves to allocate the brand funds within each of the brands.

### REFERENCE TO RELATED CASE

This application claims priority under 35 U.S.C. § 119 (e) to U.S. provisional application No. 63/075,282 filed on Sep. 7, 2021, the contents of which are hereby incorporated by reference in their entirety.

### BACKGROUND OF THE INVENTION

Commercial businesses usually have one or more brands (or products) that they need to promote to their customers and potential customers. There are a range of media channels (or commercial channels as used herein) for the businesses to choose from when making these commercial investment decisions e.g. television, radio, online, outside sales force, tele-sales etc. The managers of the businesses and the brands need a rational way to allocate the funds across the brands and across the commercial channels to meet their business objectives e.g. maximize long-term profits.

Currently companies often use commercial channel response curves to allocate their spending across each commercial channel. A commercial channel response curve is an estimate of how the sales of a brand will vary at different levels of commercial channel investment for a specific time period (usually a year). A variety of techniques can be used to derive each commercial channel's response curve e.g. econometric modelling, AI machine learning, and human judgment. Once all the commercial channel response curves have been created for all the brands, an optimization routine is used to find the optimum allocation of the commercial budget across all the commercial response curves for all the brands based on an optimization criteria e.g. maximizing profits over three years. The incremental impact of changes to each commerical response curve is calculated and summed up to the brand level.

The problem with this approach is it tends to over-allocate investment to fast growing and generally responsive brands; and because the incremental impacts are additive, it often produces unrealistically high sales forecasts for these fast-growing brands. Furthermore, this approach often takes too much commercial investment from declining or unresponsive brands and—due to the additive nature of the incremental impacts—produces unrealistically low sales forecasts for these brands. These unrealistic forecasts reduce the confidence in the overall approach.

Thus, there is a need for a better way to determine how to allocate the funds to be spent for each of the brands in a variety of commercial channels.

### SUMMARY OF THE INVENTION

The present invention is directed to a process of allocating and procuring commercial resources for a plurality of brands over a plurality of commercial channels to arrive at a total commercial budget that includes providing a plurality of commercial response curves using the plurality of commercial channels and the plurality of brands. providing a plurality of brand response curves for total commercial brand investment, each of the plurality of brand response curves being associated with one of the plurality of brands. for each brand in the plurality of brands, determining an allocation of the total commercial budget for each brand using optimization technology and the plurality of brand response curves to arrive at a brand allocation of the total commercial budget for each of the brands in the plurality of brands, to maximize a total responsiveness across the plurality of brands, for each brand in the plurality of brands, using optimization technology to determine an allocation of the brand allocation for each of the brands in the plurality of brands using the brand's commercial-channel response curves to maximize a total commercial channel response across all commercial channels for each brand, calculating a total fund for each of the commercial channels across the plurality of brands, and procuring the commercial resources in each of the commercial channels based upon the total funds.

In some embodiments, the commercial-channel response curve is determined using at least one method that includes econometric modelling, AI machine learning, and human judgment.

In some embodiments, the optimization technology includes the use of an optimization algorithm.

In some embodiments, the optimization algorithm may be either linear or non-linear.

In some embodiments, the optimization algorithm includes simulated annealing algorithms, genetic algorithms, and gradient descent algorithms.

In some embodiments, the optimization algorithms are implemented in software routines that include at least one of ScyPy, CVOPT, pyOpt, AP Monitor, and a custom software library

In yet another aspect, there is a process of allocating and procuring commercial resources for a plurality of brands over a plurality of commercial channels to arrive at a total commercial budget that includes creating a plurality of commercial response curves using the plurality of commercial channels and the plurality of brands, creating a plurality of brand response curves for total commercial brand investment, each of the plurality of brand response curves being associated with one of the plurality of brands, for each brand in the plurality of brands, determining an allocation of the total commercial budget for each brand using the plurality of brand response curves to arrive at a brand allocation of the total commercial budget for each of the brands in the plurality of brands, to maximize a total responsiveness across the plurality of brands, for each brand in the plurality of brands, determine an allocation of the brand allocation for each of the brands in the plurality of brands using the brand's commercial-channel response curves to maximize a total commercial channel response across all commercial channels for each brand, calculating a total fund for each of the commercial channels across the plurality of brands; and procuring the commercial resources in each of the commercial channels based upon the total funds.

In yet another aspect, there is a system for allocating and procuring commercial resources for a plurality of brands over a plurality of commercial channels to arrive at a total commercial budget that includes a memory, a processor in communication with the memory and to issue processing instructions stored in the memory, the processing instructions that include retrieving a plurality of commercial response curves using the plurality of commercial channels and the plurality of brands, retrieving a plurality of brand response curves for total commercial brand investment, each of the plurality of brand response curves being associated with one of the plurality of brands, for each brand in the plurality of brands, determining an allocation of the total commercial budget for each brand using optimization technology and the plurality of brand response curves to arrive at a brand allocation of the total commercial budget for each of the brands in the plurality of brands, to maximize a total responsiveness across the plurality of brands, for each brand in the plurality of brands, using optimization technology to determine an allocation of the brand allocation for each of the brands in the plurality of brands using the brand's commercial-channel response curves to maximize a total commercial channel response across all commercial channels for each brand, and calculating a total fund for each of the commercial channels across the plurality of brands so that the commercial resources can be procured in each of the commercial channels based upon the total funds.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is one example of a commercial response curve for one brand and one commercial channel;

FIG. 2 is one example of a plurality of commercial response curves for one brand and a plurality of commercial channels;

FIG. 3 is one example of a brand response curve for one brand over all commercial channels;

FIG. 4 is flow chart illustrating the one embodiment of the process according to the present invention;

FIG. 5 another example of a plurality of commercial response curves for two brands and a plurality of commercial channels, including television, radio and Sales Force; and

FIG. 6 is a schematic of one embodiment of a system for allocating and procuring commercial resources according to the present invention.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

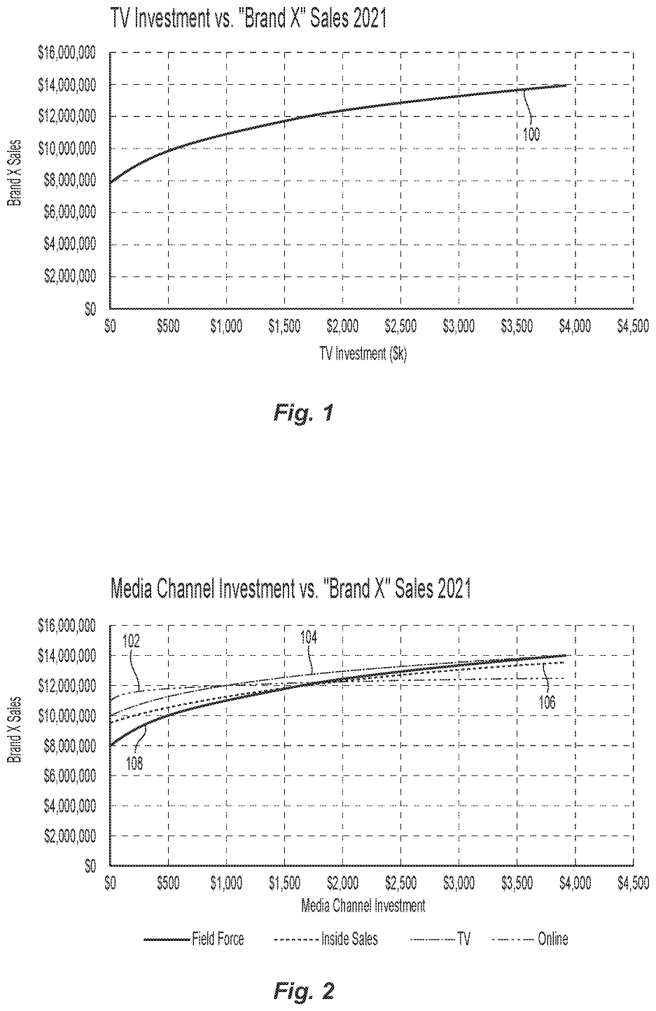

Illustrated in FIGS. 1 and 2 is a response curve, and those who decide how to spend money for a particular brand or product may use one to estimate how the sales of that product will vary at various levels of investment. These response curves may be called either commercial channel response curves or commercial response curves. In the example in FIG. 1 there is a single brand or product (labeled as “Brand X”) and a single commercial channel—TV that are used to create the commercial response curve 100. It is known in the art that there can be several different products and/or several different commercial channels (e.g., sales force, Field Force, advertising, social media, tele-sales, billboards, tv advertising, arena advertising, digital advertising, and radio announcements) that are graphed. For example, in FIG. 2 there are a plurality of commercial response curves. For a single Brand X, there are four curves representing different media or commercial channels: an online curve 102, an inside sales curve 104, a TV sales curve 106, and a Field Force curve 108. These curves can be generated in a number of ways, including econometric modelling, AI machine learning, and human judgment. There may also be significant historical data that may also be used to generate the curves. Those skilled in the art of statistical analysis and response modeling can decide which of these techniques or others can be used. Typically, once these commercial response curves have been created for all of the brands, an optimization routine or technique is used to find the optimum allocation of the commercial budget across all the commercial response curves for all the brands. As illustrated in FIG. 5, there may be a number of curves on each graph. For example, there is illustrated two different brands (Brand A and Brand B) and three different commercial channels (TV, Radio, and Sales Force).

The optimization is typically done based on a particular criteria, e.g., maximizing profits over three years. Other criteria may also be used in the optimization process. The incremental impact of the changes to each commercial response curve is calculated and summed up to the brand level. As noted above, this method tends to over-allocate investment to fast growing and generally responsive brands and often takes too much media investment from declining or unresponsive brands.

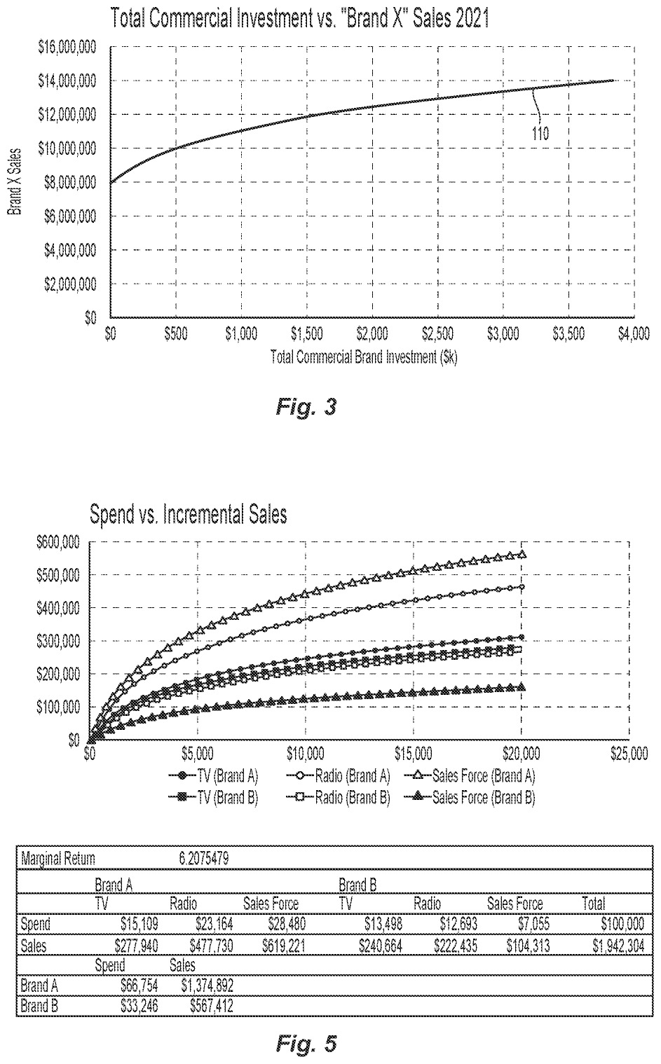

The current process, while also using the commercial response curves, also adds another curve—the brand level response curve, or the brand response curve. The brand response curve reflects the total commercial investment for a single brand and the brand's total sales. Such a brand response curve is illustrated in FIG. 3. The curve 110 illustrates the total expenditures for Brand X across all of the commercial channels. It is also possible to add other brands to the graph, but there will a brand response curve for each of the brands/products that are to be optimized, whether in separate or the same graphs.

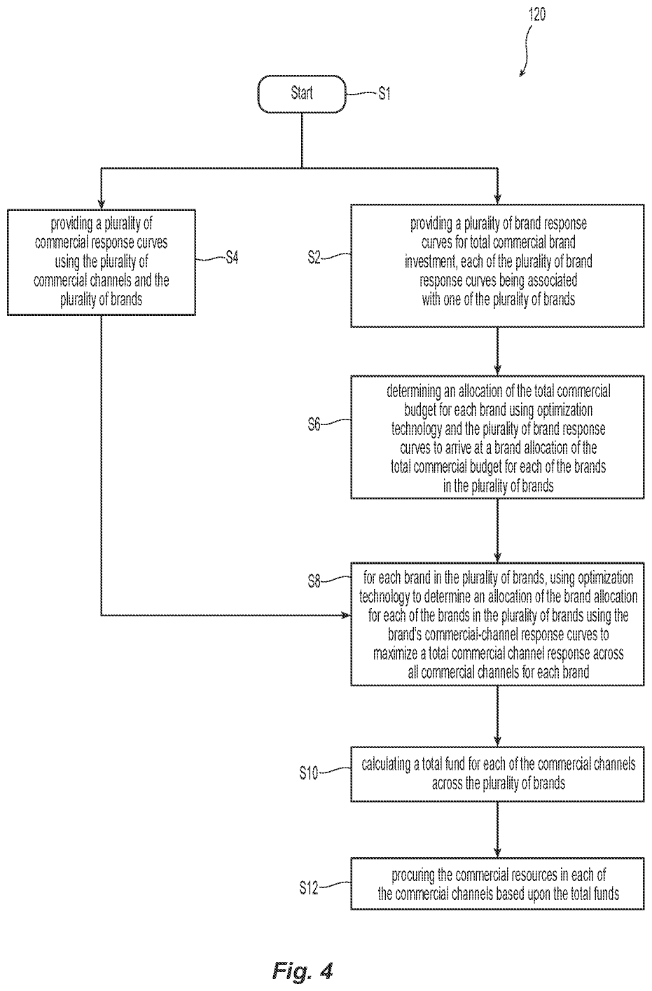

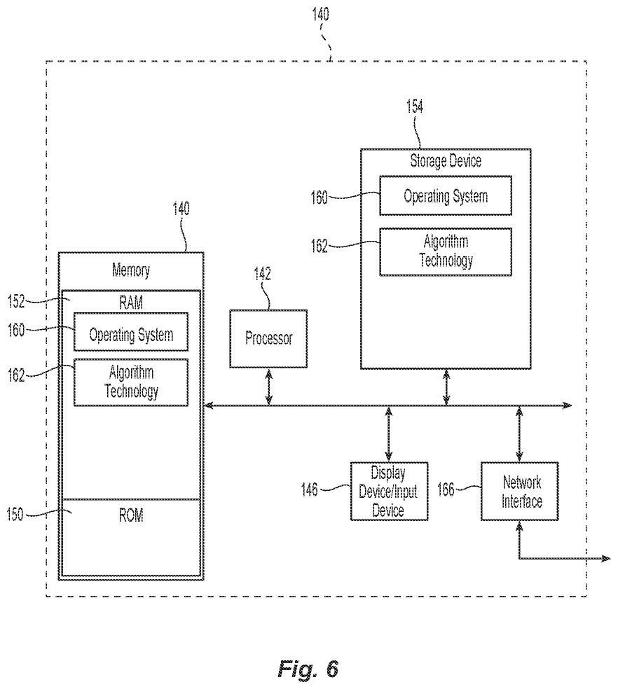

Turning to FIG. 4, the process allocating and procuring commercial resources for a plurality of brands over a plurality of commercial channels according to the present invention will be described.

The process 120 is started at step S1. At step S2, the process includes providing a plurality of commercial response curves using the plurality of commercial channels that are used for the brands and the plurality of brands. The process 120 may use curves that were previously generated or curves may be generated at this step. Then at step S4, the process 120 includes providing a plurality of brand response curves for total commercial brand investment, each of the plurality of brand response curves being associated with one of the plurality of brands. As with step S2, the process 120 may use curves that were previously generated or curves may be generated at this step. It should be realized that step S4 can precede step S2 and still fall within the scope of the present invention.

Then at step S6, the process determines, for each brand in the plurality of brands, an allocation of the total commercial budget for each brand using optimization technology and the plurality of brand response curves to arrive at a brand allocation of the total commercial budget for each of the brands in the plurality of brands, to maximize a total responsiveness across the plurality of brands. Thus, rather than determining the allocation for each of the commercial channels as in the prior art, the allocation for each of the brands is determined in this step, regardless of the number of brands. The optimization is, as noted above, performed using an optimization algorithm, which may be either a linear or non-linear algorithm. Additionally, the optimization algorithm may simulated annealing algorithms, genetic algorithms, and gradient descent algorithms. As noted in more detail below, the optimization algorithms may be implemented in software routines that include at least one of SciPy, CVOPT, pyOpt, AP Monitor, and a custom software library.

At step S8, the process uses then optimization technology, the same or similar as noted above, to determine an allocation of the brand allocation for each of the brands in the plurality of brands using the brand's commercial-channel response curves to maximize a total commercial channel response across all commercial channels for each brand. It is at this point that for each of the brands, the optimization determines the amount to be allocated for each of the commercial channels from the brand allocation and not from the total budget.

At step S10, the process then calculates a total fund or amount for each of the commercial channels across the plurality of brands. Thus, the total budget is now realized and, in the final step of S12, the commercial resources in each of the commercial channels based upon the total funds can be procured.

While it is not necessary, it is possible to have the process performed by a system. One embodiment of such a system 140 according to the present invention. As may be understood the system 140 includes a processor 142 that communicates with other elements within the system 140 via a system interface or system bus 144. Also included in the system 140 is a display device/input device 146 for receiving and displaying data. This display device/input device 146 may be, for example, a keyboard, a touch-sensitive screen, or a pointing device that is used in combination with a monitor. The system 140 further includes memory 148, which preferably includes both read only memory (ROM) 150 and random access memory (RAM) 152. The system's ROM 150 is used to store appropriate systems that help to transfer information between elements within the system 140.

In addition, the system 140 includes at least one storage device 154, such as a flash drive, a hard disk drive, a floppy disk drive, a CD Rom drive, or optical disk drive for storing information on various computer-readable media, such as a hard disk, a removable magnetic disk, or a CD-ROM disk. As will be appreciated by one of ordinary skill in the art, each of these storage devices 154 is connected to the system bus 144 by an appropriate interface. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 152. Such program modules include an operating system 160 and the optimization technology 162, as well as commercial response curves and brand response curves. The optimization technology 162 includes the optimization algorithms that are used with the brand response curves and the commercial response curves to find the optimal allocations as discussed above. The optimization technology 162 is used by the processor 142 with the information stored in the memory or other inputs from the input device 146. The optimization algorithms be either linear or non-linear. Additionally, the optimization algorithm may simulated annealing algorithms, genetic algorithms, and gradient descent algorithms, which may be stored in the memory or provided by an external source. The optimization algorithms may be implemented in software routines that include ScyPy, CVOPT, pyOpt, AP Monitor, and a custom software library, which may be stored in memory or provided by an external source.

Also located within the system 140 is a network interface 166, for interfacing and communicating with other elements of a computer network if so desired. It will be appreciated by one of ordinary skill in the art that one or more of the system 140 components may be located geographically remotely from other system 140 components. Furthermore, one or more of the components may be combined, and additional components performing functions described herein may be included in the system 140.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

I claim:

1. A process of allocating and procuring commercial resources for a plurality of brands over a plurality of commercial channels to arrive at a total commercial budget comprising:
providing a plurality of commercial response curves using the plurality of commercial channels and the plurality of brands;
providing a plurality of brand response curves for total commercial brand investment, each of the plurality of brand response curves being associated with one of the plurality of brands;
for each brand in the plurality of brands, determining an allocation of the total commercial budget for each brand using optimization technology and the plurality of brand response curves to arrive at a brand allocation of the total commercial budget for each of the brands in the plurality of brands, to maximize a total responsiveness across the plurality of brands;
for each brand in the plurality of brands, using optimization technology to determine an allocation of the brand allocation for each of the brands in the plurality of brands using the brand's commercial-channel response curves to maximize a total commercial channel response across all commercial channels for each brand;
calculating a total fund for each of the commercial channels across the plurality of brands; and
procuring the commercial resources in each of the commercial channels based upon the total funds.

2. The process according to claim 1, wherein the commercial-channel response curve is determined using at least one method that includes econometric modelling, AI machine learning, and human judgment.

3. The process according to claim 1, wherein the optimization technology includes the use of an optimization algorithm.

4. The process according to claim 3, wherein the optimization algorithm may be either linear or non-linear.

5. The process according to claim 3, wherein the optimization algorithm includes simulated annealing algorithms, genetic algorithms, and gradient descent algorithms.

6. The process according to claim 5, wherein the optimization algorithms are implemented in software routines that include at least one of SciPy, CVOPT, pyOpt, AP Monitor, and a custom software library.

7. The process according to claim 1, wherein the commercial channels include at least one of the commercial channels that includes sales force, advertising, social media, tele-sales, billboards, tv advertising, arena advertising, digital advertising, and radio announcements.

8. The process according to claim 1, wherein the step of providing a plurality of commercial response curves occurs after the step of providing a plurality of brand response curves.

9. The process according to claim 1, wherein the steps of providing a plurality of commercial response curves and providing a plurality of brand response curves includes generating each of the response curves.

10. A process of allocating and procuring commercial resources for a plurality of brands over a plurality of commercial channels to arrive at a total commercial budget comprising:
creating a plurality of commercial response curves using the plurality of commercial channels and the plurality of brands;
creating a plurality of brand response curves for total commercial brand investment, each of the plurality of brand response curves being associated with one of the plurality of brands;
for each brand in the plurality of brands, determining an allocation of the total commercial budget for each brand using the plurality of brand response curves to arrive at a brand allocation of the total commercial budget for each of the brands in the plurality of brands, to maximize a total responsiveness across the plurality of brands;
for each brand in the plurality of brands, determine an allocation of the brand allocation for each of the brands in the plurality of brands using the brand's commercial-channel response curves to maximize a total commercial channel response across all commercial channels for each brand;
calculating a total fund for each of the commercial channels across the plurality of brands; and
procuring the commercial resources in each of the commercial channels based upon the total funds.

11. The process according to claim 10, wherein the determination of the allocation of the total commercial budget for each brand includes using optimization technology.

12. The process according to claim 10, wherein the determination of the brand allocation for each of the brands includes using optimization technology.

13. A system for allocating and procuring commercial resources for a plurality of brands over a plurality of commercial channels to arrive at a total commercial budget comprising:
a memory;
a processor in communication with the memory and to issue processing instructions stored in the memory, the processing instructions including;
retrieving a plurality of commercial response curves using the plurality of commercial channels and the plurality of brands;
retrieving a plurality of brand response curves for total commercial brand investment, each of the plurality of brand response curves being associated with one of the plurality of brands;
for each brand in the plurality of brands, determining an allocation of the total commercial budget for each brand using optimization technology and the plurality of brand response curves to arrive at a brand allocation of the total commercial budget for each of the brands in the plurality of brands, to maximize a total responsiveness across the plurality of brands;
for each brand in the plurality of brands, using optimization technology to determine an allocation of the brand allocation for each of the brands in the plurality of brands using the brand's commercial-channel response curves to maximize a total commercial channel response across all commercial channels for each brand; and
calculating a total fund for each of the commercial channels across the plurality of brands so that the commercial resources can be procured in each of the commercial channels based upon the total funds.

14. The system according claim 13, wherein the processor generates the plurality of commercial response curves and the plurality of brand response curves from data stored in the memory.
